(19) United States
(12) Patent Application Publication
(10) Pub. No.: US 2009/0320474 A1
(43) Pub. Date: Dec. 31, 2009

(54) HEAT RECOVERY FROM GEOTHERMAL SOURCE

(76) Inventor: Stuart Giles, Port Hope (CA)

Correspondence Address: Muncy, Geissler, Olds & Lowe, PLLC, P.O. BOX 1364, FAIRFAX, VA, 22038-1364, US

(21) Appl. No.: 12/309,867

(22) PCT Filed: Aug. 3, 2007
(86) PCT No.: PCT/CA2007/001369

§ 371 Date: Feb. 2, 2009

(30) Foreign Application Priority Data
Aug. 4, 2006 (CA) 2,555,488

(51) Int. Cl. F03G 4/00

(52) U.S. Cl. 60/641.2

(57) ABSTRACT

Water, air, other fluid flows downwardly through a tube which extends from the surface of an underground mine to a number of conduits arranged in loops which extend into bore holes at or near the bottom of the shaft. The fluid in the conduits remains isolated from the walls of the bore holes to prevent contamination by minerals in the walls. The fluid remains in the conduits while its temperature rises by geothermal action. The heated fluid is then pumped through a second tube to a station at which the ambient temperature is lower than that of the fluid. Thermal energy is extracted from the heated fluid at the station.

### FIELD OF THE INVENTION

This invention relates to geothermal processes and more particularly to a process which involves passing fluids such as water and other liquids as well as compressed air through a number of subterranean openings in order to raise the temperature of such fluids by the internal heat of the earth surrounding the openings after which the thermal energy from such fluids is harnessed. The thermal energy is harnessed in a number of different ways. The heated fluid can, for example, be used to heat structures such as factories, office buildings and houses. Where the fluid is water, the water can be preheated geothermally in the first step of a multi-step heating process for the production of steam. The steam can be used to drive a steam turbine for the generation of electricity, for heating buildings and for other purposes.

### BACKGROUND OF THE INVENTION

It is well known that the temperature of fluids can be raised by means of geothermal energy from the heat of the earth. The temperature of earth rises with increasing depth from the surface and the temperature of liquids likewise rises as the depth of their surroundings underground increases. When the liquid is extracted from the earth, its thermal energy can be harnessed in ways that depend upon the depth at which the liquid is situated. For example, water at a depth of about 2.5 km, is generally in the form of steam. In areas of volcanic activity and thermal springs, steam occurs at considerably lesser depths. The steam when extracted from the earth can be injected directly onto the blades of a turbine in order to drive a generator.

Liquid is conventionally heated geothermally by causing it to flow downward from the surface of the earth through a bore hole to a predetermined depth. The heated liquid is then returned to the earth's surface through another bore hole. The cost of drilling two such bore holes is considerable. Moreover, while the liquid is at that depth, it frequently combines with substances such as silica and soluble minerals. Such minerals contaminate the liquid and must be removed before the thermal energy from the liquid can be harnessed. The cost of decontaminating the heated liquid is considerable and that cost as well as the cost of drilling the bore holes are major deterrents to the widespread substitution of geothermal energy for energy produced by conventional means such as the combustion of oil and natural gas.

I have found that fluids can be heated geothermally without the necessity of drill holes and decontaminants. Fluids can flow between the earth's surface and sites beneath the surface through conduits located in the vertical shafts of underground mines. Such shafts are conventionally provided for hoisting ore to the surface for transport to a smelter or chemical extractor and for cages for transporting miners to and from the excavations underground.

There is no necessity to drill bore holes for the fluid which is to be heated geothermally. Containers for the fluid while it is being heated geothermally can be installed in openings at the bottom of the shafts. The fluid is accordingly isolated from the earth during the period of time that it flows through conduits such as pipes downward from the earth's surface, while it is being heated geothermally and while it returns to the surface. The fluid is never in contact with the surrounding earth. There is therefore no necessity to decontaminate the heated fluid

### SUMMARY OF THE INVENTION

The process of my invention can conveniently be carried out in existing underground mines, preferably in abandoned ones. Such mines generally have vertical shafts that extend sufficiently far underground that there is a significant increase in the temperature at the bottom of the shafts over that at the top of the shafts. Conduits through which liquids can travel to and from the surface of the earth and the bottom of the mine can conveniently be located in the shafts. Furthermore mines generally have caverns, stopes and other openings at the bottom of their shafts which can contain numerous banks of conduits. Such conduits have sufficient capacity to accommodate liquids for the period of time required for their temperature to increase to ambient temperature.

Since the process of my invention is carried out in an underground mine, no holes need be bored to accommodate conduits nor large underground openings need be excavated. The cost of carrying out the process is accordingly significantly lower than conventional processes where such bore holes and underground openings need be constructed.

Briefly, one of the ways in which the geothermal processes of my invention is carried out involves the steps of: providing a subterranean station in communication with a vertical shaft of an underground mine and within which a first container is located; providing a first conduit which extends vertically downward within the shaft and which extends to the first container; causing fluid to flow downwardly through the conduit and to flow to the first container, the fluid being at a temperature lower than the ambient temperature at the subterranean station; causing the fluid to remain within the first container for a period of time sufficient for the fluid to be heated by geothermal action; providing a second conduit which extends from the first container to another station at which the ambient temperature is at or lower than that at the subterranean station; causing the heated fluid to flow from the first container to the other station; and extracting thermal energy from the heated fluid at the other station.

The above-described geothermal process can be modified by providing a number of subterranean openings which extend outwardly from the subterranean station. The fluid is caused to circulate through the openings in order to cause the fluid to be heated by the internal heat of the earth surrounding the openings. The openings may be drill holes of relatively small diameter or they may be existing stopes, openings or caverns.

### DESCRIPTION OF THE DRAWING

The geothermal processes of my invention are described with reference to the drawing in which:

FIG. 1 shows schematically, the components used to carry out one of the processes of my invention; and

FIG. 2 shows schematically a subterranean station where the fluid is heated by geothermal means.

Like reference characters refer to like parts throughout the description of the drawing.

### DESCRIPTION OF THE PREFERRED STEPS OF THE PROCESS

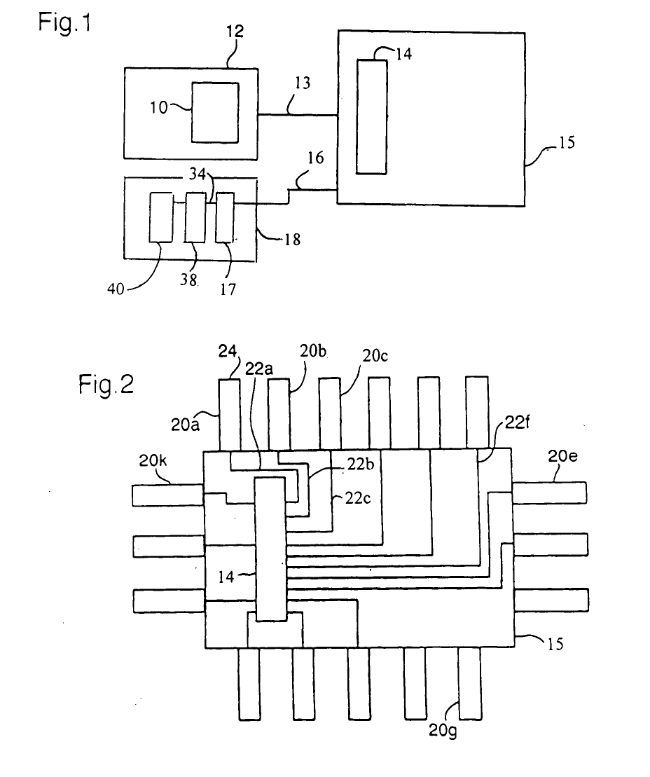

With reference to FIG. 1, water at ambient temperature is collected at an upper station 12 which may be on the surface of the earth or near the surface. The water flows downward through a conduit 13, located within a vertical mine shaft of an underground mine. The water flows to a first container 14 located within a subterranean station 15. The ambient temperature at the subterranean station is higher than the ambient temperature at the upper station.

The water remains within the first container for a period of time sufficient for the water to be heated by geothermal action. A second conduit 16 extends from the first container upwardly through the mine shaft to a second container 17 at a second station 18. That station is on the surface of the earth. The heated water in the first container is pumped to the second station through the second conduit 16.

With reference to FIG. 2, the subterranean station 15 is a stope or other hollow chamber from which a number of openings or tunnels 20a,b . . . extend. Third conduits 22 extend outwardly from the container. The third conduits are in the form of loops and extend from the container, continue to the outer end 24 of each tunnel and return to the same or a second container. As the water flows first outwardly and into the tunnels and then inwardly, it is heated by the internal heat of the earth surrounding the tunnels. Water within the returning portions of the conduits is recombined in the container.

The foregoing process serves to preheat the water for use at the second station.

As previously indicated, the stream of preheated water is pumped upward through conduit 16 to second container 17 located within upper station 18 which may or may not be the same as station 12. The preheated water flows through a conduit 34 from the second container to a third container 38 where it is further heated by conventional means such as by gas or electricity to a temperature at which it converts to steam. The steam drives a conventional turbine 40 for the production of electrical power.

The preheated water, whether further heated in tank 38 or not, can also be used as a source of heat for heating structures such as factories, office buildings and houses on the surface of the earth.

It should be noted that the water throughout the foregoing process is isolated in conduits 13, 16 and in container 14 and does not contact the walls of the stope, hollow chamber or tunnels underground. The water therefore is not contaminated by the minerals, salts and other substances in the subterranean walls Air instead of water can be heated by the same geothermal process described above. To this end and with reference again to FIG. 1, air is compressed by means of a conventional air compressor located at upper station 12 and the compressed air flows downward through conduit 13 to a manifold 14. The manifold separates the compressed air into separate streams and directs each stream into a separate conduit 22a,b,c . . . in which the air is heated geothermally. The heated compressed air within the returning segments of the conduits is recombined in the manifold. The compressed air can be returned to the upper station 18 and further heated to increase its pressure sufficiently to drive turbine 40. The turbine may of course be located elsewhere on the earth's surface or it can be located underground in a subterranean station

The water, rather than being separated into separate streams, can be in one stream which passes through each loop 22 in turn. In such case, the loops are connected in series so that the water which exits from one loop enters the next loop in succession.

The fluids mentioned in the foregoing description are water and air. Other liquids and gases can be used. The suitability of one fluid over another under differing conditions is well known to persons skilled in the art.

It will be understood, of course, that modifications can be made in the processes of the subject invention without departing from the scope and purview of the invention as defined in the appended claims.

1-8. (canceled)

9. A geothermal process for the production of energy including the steps of (i) providing a subterranean station in communication with a vertical shaft of an underground mine and within which a manifold is located; (ii) providing a number of subterranean tunnels or bore holes which extend outwardly from said subterranean station; (iii) providing a first conduit which extends downward within said shaft and which extends to said manifold; (iv) providing a second conduit which extends from said subterranean station to a second station at which the ambient temperature and/or pressure is at or lower than that at said subterranean station; (v) providing a plurality of third conduits which extends from said manifold through said tunnels or bore holes; (vi) causing fluid to flow downwardly through said first conduit and to enter said station at a temperature lower than the ambient temperature at said subterranean station then to flow outwardly of said subterranean station through said third conduits and finally to flow to said second station; (vii) causing said fluid to remain in said subterranean station and said tunnels or bore holes for a period of time sufficient for said fluid to be heated by geothermal action; (viii) isolating said fluid from contact with walls which define said subterranean station and said tunnels or bore holes; and (ix) extracting thermal energy from said heated fluid at said second station.

10. The process of claim 9 wherein said third conduits are in the form of a plurality of loops, each of which extends from said manifold, continues to an outer end of a separate said tunnel or bore hole and returns to said manifold.

11. The process of claim 9 wherein said fluid is water.

12. The process of claim 9 wherein said fluid is compressed air.

13. A geothermal process for the production of energy including the steps of (i) providing a subterranean station in communication with a vertical shaft of an underground mine and within which a manifold is located; (ii) providing a number of subterranean tunnels or bore holes which radiate outwardly from said subterranean station; (iii) providing a first conduit which extends downward within said shaft and which extends to said manifold; (iv) providing a second conduit which extends from said subterranean station to a second station at which the ambient temperature and/or pressure is at or lower than that at said subterranean station; (v) providing a third conduit in the form of a plurality of loops, each of which extends from said manifold, continues to an outer end of a separate said tunnel and returns to said manifold; (vi) causing compressed air to flow downwardly through said first conduit and to enter said manifold at a temperature lower than the ambient temperature at said subterranean station; (vii) separating said compressed air within said manifold into a plurality of separate streams and directing each said stream into a separate said loop such that said compressed air flows outwardly of said manifold through said loops and returns to said manifold; (viii) causing said returned compressed flow through said third conduit to said second station; (ix) causing said compressed air to remain in said subterranean station and said tunnels or bore holes for a period of time sufficient for said compressed air to be heated by geothermal action; (x) isolating said compressed air from contact with walls which define said subterranean station and said tunnels or bore holes; and (xi) extracting thermal energy from said heated compressed air at said other station.
